(19) United States
(12) Patent Application Publication
(10) Pub. No.: US 2021/0189642 A1
(43) Pub. Date: Jun. 24, 2021

(54) COMPOSITION CONSISTING OF PLANT MATERIALS HAVING CELLULOSE, IN PARTICULAR FROM WASTE PRODUCTS OF APPLES, FOR PRODUCING A LAMINATE, METHOD FOR PRODUCING A LAMINATE FROM PLANT MATERIAL HAVING CELLULOSE, IN PARTICULAR FROM WASTE PRODUCTS OF APPLIES, AND LAMINATE PRODUCED BY SAID METHOD

(71) Applicant: Frumaf Srl, Bolzano (IT)

(72) Inventor: Hannes PARTH, Bolzano (IT)

(21) Appl. No.: 16/756,867

(22) PCT Filed: Oct. 17, 2018
(86) PCT No.: PCT/EP2018/078450

§ 371 Date: Apr. 17, 2020

(30) Foreign Application Priority Data
Oct. 18, 2017 (IT) 102017000117459

(51) Int. Cl. D06N 3/02; C09D 101/02; D06M 15/564; D06M 15/05; D06N 3/14

(52) U.S. Cl. CPC D06N 3/02; C09D 101/02; D06M 2101/32; D06M 15/05; D06N 3/14; D06M 15/564

(57) ABSTRACT

The invention relates to a composition for forming artificial leather said composition comprises at least one polymer and plant powder from plant remains having cellulose, having a grain size of 1 μm to 1 mm and a moisture content of less than 20 weight percent.

### BACKGROUND ON THE INVENTION

A composition consisting of plant material with cellulose, in particular from waste products from apples to produce a laminate, and a method for producing a laminate from plant material with cellulose, in particular from waste products from apples, and laminate produced by said process.

Publication WO 2008/012662 describes a composition made from the remains of the fruit industry, in particular from the processing of apples. The composition, which is described in WO 2008/012662, consists of apple powder mixed with an adhesive, in particular a natural adhesive. The composition produced by the method described can be brought into a laminate form which is similar to leather. The problem with the composition described is the difficult processing and the low resistance to stress and use. A product made of artificial leather is known from PD 2012 A000 227, which is biodegradable.

This includes the following layers in order:
a base layer made of natural fibres,
a middle layer formed by a coagulated foam,
a polymer surface, preferably of biodegradable polymer.

In particular, the base layer is made from fibres, in particular natural fibres, and/or from a non-woven fabric.

The product produced with this method has a surface very

similar to leather in terms of aesthetics and tactility.

Primary resources are also used.

A composition for producing artificial leather is known from

JP H04 30442A. The resin used in JP H0430442A is an artificial resin and the desired properties can only be archived by using the artificial resin.
Also, a plant protein is used.

To produce plant proteins, the plant material has to undergo a number of processes.

In addition, the use of plant proteins is linked to certain characteristics of the material to be used.

### SUMMARY OF THE INVENTION

The object of the present invention is to form a composition for realizing a laminate which is formed from plant material with cellulose, in particular a method for producing a laminate which comprises residues from the food industry and which can be used on an industrial scale, and which is a laminate produced by the above-mentioned method and which is a resistant laminate which can be produced industrially.

This object can be achieved by a composition according to the invention with a method comprising a first method by applying the composition and/or a second method by means of a coagulation method.

The first method according to the invention comprises the following steps:
a first step of preparing a textile support structure,
a second step in which a composition with at least one polymer and a powder from plant residues with cellulose with a grain size that is less than 1 mm is applied.

For the method according to the invention, an additive can be used, which preferably consists of at least one polymer, a natural polymer, and of powder from plant residues with cellulose with a moisture content of less than 20% and a grain size less than 1 mm.

The method according to the invention is used to produce a laminate.

This laminate is similar to leather both in its visual characteristics and has a durability similar to leather.

From the point of view of the use of resources, the method according to the invention proposes a more ecological and eco-compatible solution than is known from the state of the art.

In a second method, this is achieved using a coagulation procedure. This industrial method consists in impregnating a carrier material, for example a non-woven fabric with a dissolved polymer. This dissolved polymer is based on polyurethane, preferably from a renewable/biological source, for example thermoplastic polyurethane.

This solution provides foaming in a preferred manner with controllable cell formation. This coagulated foam is formed by a composition comprising a thermoplastic polyurethane comprising a base of ester/ether/carbonate and their plasticized mixtures, powder of cellulose, additives for coagulation, cellular acetobutyrate, pigments and water.

The material composed in such a way is similar to animal leather in appearance, resistance and other characteristics, such as in the tactile area. The foaming is obtained by a chemical reaction which is exothermic in a coagulation bath with water.

In order to carry out the method according to the invention, a high quality standard and the use of specially selected materials are required.

### DESCRIPTION OF THE DRAWINGS

Further features and details of a preferred, non-limiting embodiment of the method of the invention are set out clearly below in the description and with reference to the accompanying figures.

### DESCRIPTION OF THE FIGURES

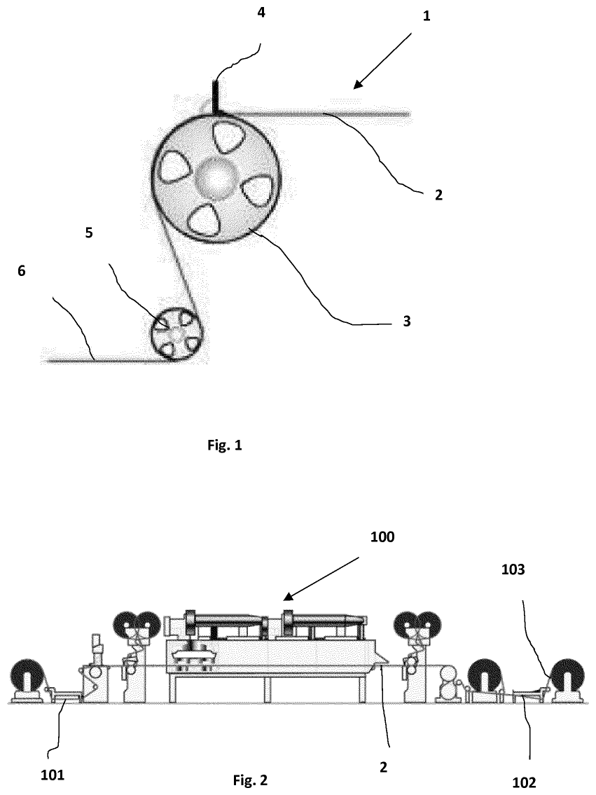

FIG. 1 shows a distributor for applying the material,

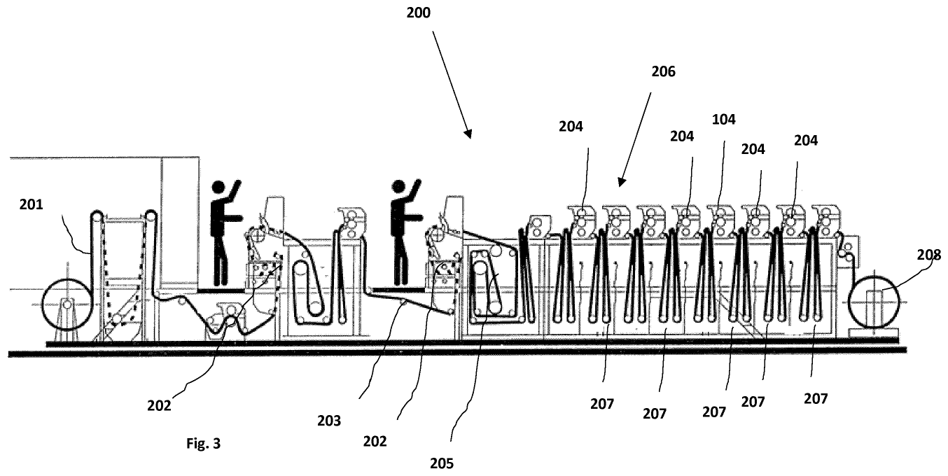

FIG. 2 shows an installation according to the invention for processing the material,

FIG. 3 shows a second installation in order to use a method according to the invention,

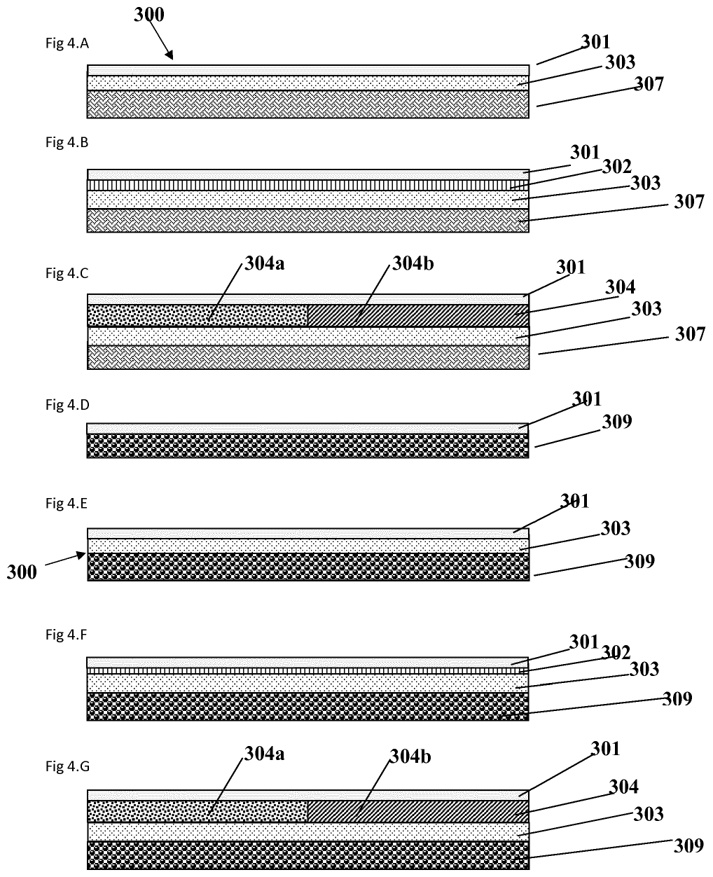

FIGS. 4A, 4B, 4C an inventive laminate, manufactured with a first method, and

FIGS. 4D, 4E, 4F show an inventive laminate produced with a second method, which comprises a bath.

### DETAILED DESCRIPTION OF THE INVENTION

FIG. 1, with reference to FIG. 1, denotes a device for applying material to a base layer. According to the invention, a polyurethane solution is applied from a layer of a textile material 2, which in a preferred embodiment can be a material made of natural fibres, for example a non-woven fabric. This polyurethane solution is applied to the fabric base 2. This polyurethane solution comprises a powder made from dry or dried fruit with cellulose.

This fruit powder with cellulose has a moisture content between 1-20%, preferably between 2% and 15% and a grain size between 1μ-1 mm, particularly between 1μ-450μ. The use of apple powder is particularly advantageous. In particular, apple powder is used which is obtained from the remains of industrial processing, for example from the remains of the apple juice industry or the like.

In a second step, pigments or other additives are added to form

the water-based colours.

In a third step, additional coagulating additives are applied. In order to fix the applied material better on the fabric base, an additional layer of composite polymer made of polyurethane polymers in aqueous form or dissolved pigments and water-based colours or coagulating solvents and coagulating additives.

A laminate 300 which is produced by such a method is shown in FIGS. 4A, 4b and 4c. In FIG. 4A, this laminate 300 comprises a first layer 301 made of polyurethane, preferably biological polyurethane, mediums for facilitating levelling, mediums for hardening, pigments, binders etc. and 303 is made of polyurethane and the plant material with cellulose. All of this is applied to the base layer 307, which consists of non-woven fabric, fabric, fabric made of natural fibres, jersey fabric, fabric made of polyester and the like.

In FIG. 4B, the layer 302 is applied between layers 301 and 303. This is similar to the layer 303, and slightly smaller amounts of plant material with cellulose may be used. In FIG. 4C, the layer 304 is located between the layers 301 and 303. This can be constructed from foamed or compact materials, which is, according to the invention, a composition with a higher proportion of plant material with cellulose than in layer 303.

In a second method, a fabric base, for example a non-woven fabric made of 100% viscose, is immersed in a solvent, which comprises a composition according to the invention, preferably a polymer from a renewable source based on a thermoplastic polyurethane, dried fruit powder with cellulose, preferably powder from remains of the apple industry, other plant substances in various colours and additives for coagulation.

As a renewable/biological source, one understands polymers which are produced from plants, fruits, seeds, algae or other renewable raw materials. The carrier layer according to the invention and the composition according to the invention coagulate after they are immersed in a tank with solvent and form the surface structure. This method has the following advantages: the fact that the composition according to the invention is used forms the base layer, for example the carrier with the composition forms a single layer, thereby the materials are connected. In the first method according to the invention the composition is applied to the base layer. The advantage of the first method is that the surface can be processed better and/or structured, for example by a decal/layer, and no solvents are used, while the second method increases the durability and there is no risk that the two layers separate from each other, i.e. that the composition separates from the base layer.

The two processes result in a product that looks very similar to natural leather.

All other features such as physical or mechanical properties also allow the use in the above-mentioned area, i.e. it can be used as a substitute for leather or leather-like products.

The method may include applying a decal/layer to a paper base, on the surface of which a negative relief image is applied. According to the invention, this relief image is applied to the composition and thus creates a natural structure.

The surface is refined/embossed by applying polymers based on thermoplastic material, such as biological thermoplastic water-based polyurethane.

A system of wiper/coating elements, as shown in FIG. 1, and a system 100 with a drying oven, as shown in FIG. 2, creates a film with different layers which is always connected to the carrier 2 by means of an adhesive based on polyurethane. At the end of the process, the product is separated from the decal/layer. The material is passed through the oven for drying.

After the separation of the decal/layer 102, the surface structure remains embossed in the material, which makes the surface look more natural and therefore leather-like.

The so produced material is then rolled up 103. A laminate is produced by the method according to the invention. This laminate is an artificial leather, which comprises the following layers:

a first layer as a carrier layer in a fabric made of natural fibres, a second layer, which is formed from a composition according to the invention, where the composition comprises of at least one polymer and a powder of plant residues with cellulose with a grain size which does not exceed 1 mm and the plant residues contain less than 20% by weight of moisture.

In this composition, the ratio between plant residues and polymer is up to 65% plant residues and at least 35% polymer.

FIG. 3 shows a coagulation process on a system 200 in which a method according to the invention is used.

In particular, a base layer, for example non-woven fabric 201, is unwound in a first step. Then, a layer is applied according to the invention. The material is then pre-coagulated in an area 203 and then a composition 202 according to the invention can be applied again. The material with the composition according to the invention then runs through the bath 205, where the coagulation is activated. In a subsequent step 206, pressure is exerted on the material several times, for example by rolling, pressing rolls 204. The material then runs through several baths 207 to be washed. This helps to wash out the agents that were necessary for the coagulation and/or to wash out non-solidified parts. Afterwards, the laminate produced with this method is rolled up.

A laminate 300 produced by such a method is shown in FIGS. 4D, 4E, 4F and 4G. In FIG. 4D, this laminate 310 comprises a first layer 301 made of polyurethane, preferably biological polyurethane agents for facilitating levelling, agents for hardening, pigments, binders etc. and of plant material with cellulose.

All of this is applied to the base layer 309, which consists of non-woven fabric, fabric, natural fabric, fabric made of natural fibres, jersey fabric, and fabric made of polyester and the like and which combines with the layer according to the invention through the coagulation process.

The laminate 300 mentioned in FIG. 4E comprises a first layer 301 made of polyurethane, preferably biological polyurethane, means for facilitating levelling, agents for hardening, pigments, binders etc. and of the plant material with cellulose.

The second layer 303 is made of polyurethane and the plant material with cellulose.

All of this is applied to the base layer 309, which consists of non-woven fabric, fabric, fabric made of natural fibres, jersey fabric, and fabric made of polyester and the like and which is combined with the layer according to the invention by the coagulation process.

In FIG. 4F, the layer 302 is applied between the layers 301 and 303. This is structured similarly to layer 303: slightly smaller amounts of plant material with cellulose may be used.

In FIG. 4G, the layer 304 is located between the layers 301 and 303. The layer can be constructed from foamed or compact material which has a composition according to the invention with a higher proportion of plant material with cellulose than layer 303.

The variants of the method and the device described above serve only for a better understanding of the structure, the functioning and the properties of the presented solution; they do not restrict the disclosure to the exemplary embodiments. The FIGURES are schematic, with essential properties and effects being shown in a partially enlarged manner in order to clarify the functions, operating principles, technical configurations and features. Every function, every principle, every technical design and every feature, which is/are disclosed in the FIGURES or in the text, with all claims, every feature in the text and in the other FIGURES, other functions, principles, technical configurations and features which are contained in or result from this disclosure can be combined freely and in any way, so that all conceivable combinations of the described solution can be ascribed.

Combinations between all individual versions in the text, i.e. in each section of the description, in the claims and also combinations between different variants in the text, in the claims and in the FIGURES are also included. The device and method details explained above are shown in context; however, it should be noted that they are also independent of one another and can also be freely combined with one another.

The relationships of the individual parts and sections thereof shown in the FIGURES and their dimensions and proportions are not to be understood as restrictive. Individual dimensions and proportions may also differ from those shown here. The claims also do not limit the disclosure and thus the possible combinations of all the features shown. All features shown are explicitly disclosed individually and in combination with all other features.

1. A composition for the formation of artificial leather comprising at least one polymer and plant powder from plant residues with cellulose with a grain size of 1 μm to 1 mm and moisture content of less than 20% by weight.

2. The composition according to claim 1, wherein the polymer is polyurethane and the plant residues with cellulose are apples with a grain size of 1μ to 450μ.

3. The composition according to claim 2, wherein the polyurethane is made from biological material.

4. The composition according to claim 1, wherein the ratio of plant residues and polymer, up to 65% weight consists of plant materials and at least 35% weight consists of polymer.

5. A method for producing a laminate of biodegradable synthetic leather comprising a composition according to claim 1 and the following steps:
preparing a first layer of a fabric base;
applying a composition according to claim 1; and
levelling the composition which has been applied to the base and drying the composition.

6. The method according to claim 5, applying a decal/layer to the layer formed by the composition on the side opposite the fabric support base.

7. The method according to claim 5, wherein the fabric base is a non-woven fabric.

8. The method according to claim 6, wherein a decal/layer has a negative structure/relief.

9. The method for producing a laminate of biodegradable artificial leather, comprises the following steps:
preparing a first layer of a fabric base;
applying a composition according to claim 1; and
coagulating and drying the applied composition.

10. The method according to claim 9, wherein the fabric base is a non-woven fabric.

11. A composite laminate of artificial biodegradable leather, comprising the following layers:
a first layer is a carrier layer made of fabric made of fibres;
a second layer being a composition of at least one polymer and of powder from plant residues with cellulose with a maximum grain size of 1 mm, the plant residues having a moisture content of less than 20% by weight.
